(19) United States
(12) Patent Application Publication
(10) Pub. No.: US 2012/0015711 A1
(43) Pub. Date: Jan. 19, 2012

(54) ON/OFFLINE GAMING, PLAYER BACKING SYSTEM WITH ELECTRONIC CURRENCY AND COMMERCE

(75) Inventor: Timothy F. Belisle, White Bear Lake, MN (US)

(73) Assignee: IBACKU, LLC, White Bear Lake, MN (US)

(21) Appl. No.: 13/182,119

(22) Filed: Jul. 13, 2011

Related U.S. Application Data
(60) Provisional application No. 61/363,750, filed on Jul. 13, 2010.
(60) Provisional application No. 61/363,772, filed on Jul. 13, 2010.
(60) Provisional application No. 61/363,794, filed on Jul. 13, 2010.

(51) Int. Cl. A63F 13/12; A63F 9/24

(52) U.S. Cl. 463/25; 463/42

(57) ABSTRACT

An online backing method and system whereby a participant backs a contestant in a competitive game of skill for the chance to win additional electronic currency if the backed contestant satisfies predetermined performance criteria. This system provides the conversion of real currency into online gaming ‘tokens’ or electronic currency that can be used to back a contestant and earn additional electronic currency if the backed contestant satisfies predetermined performance criteria in a specified game, tournament, contest, etc. The electronic currency can be accumulated, saved and used to purchase loot in various websites, online retailers and real-world stores. This backing system has application in a large number of areas whereby one contestant is pitted against another in games or tournaments of skill.

### STATEMENT OF RELATED APPLICATIONS

This application claims priority under 35 U.S.C. §119 to U.S. Provisional Patent Application Nos. 61/363,750, filed Jul. 13, 2010, 61/363,772, filed Jul. 13, 2010, and 61/363,794 filed Jul. 13, 2010, each of which is herein incorporated by reference in its entirety.

### FIELD OF INVENTION

The present invention relates in general to a computer implemented transaction system that utilizes electronic currency or online tokens, which can for example be converted from real currency or given to users without requiring real currency exchange, for the intent of backing contestants of online games for a chance to win additional electronic currency or tokens.

### BACKGROUND OF THE INVENTION

A number of gaming systems are available for play on the Internet, including gambling sites that allow one to play games such as poker, as well as gaming sites that allow one to play games such as World of Warcraft. However, no system has been created that allows a person to back a game contestant for a chance to win additional electronic currency or tokens.

### FEATURES AND OBJECTS OF THE INVENTION

It is an object of the present invention to use all forms of advertising to gather the attention of businesses and consumers.

It is an further object of the present invention to interface with AOL customers.

It is an even further object of the present invention to allow businesses and consumers exchange electronic money, also known as cyber currency.

It is an even further object of the present invention to allow consumers to play games of skill.

It is an even further object of the present invention to interface with Groupon.

It is an even further object of the present invention to use Internet marketing as a means of advertisement.

It is an even further object of the present invention to interface with LinkedIn.

It is an even further object of the present invention to use mobile phones as a means to interface with the present invention's website.

It is an even further object of the present invention to interface with MySpace.

It is an even further object of the present invention to use a netbook as a means to interface with the present invention's website.

It is an even further object of the present invention to provide a means for On-line gaming.

It is an even further object of the present invention to use a personal computer as a means to interface with the present invention's website.

It is an even further object of the present invention to use a reverse auction method to allow businesses and consumers to compete for advertising space, ‘loot’, the chance to back an individual, etc.

It is an even further object of the present invention to provide a means for Online role playing games.

It is an even further object of the present invention to use SMS text messages as a means to communicate.

It is an even further object within the bounds of the present invention to provide the opportunity to create a stand-alone social media network for business and consumers that have access to the present invention's network and website.

It is an even further object of the present invention to interface with Twitter.

It is an even further object of the present invention to get the word out regarding the present invention using a viral marketing campaign.

It is an even further object of the present invention to use all forms of virtual currency.

It is an even further object of the present invention to employ the use of Google AdWords as appropriate.

It is an even further object of the present invention to provide a means for consumers to enter into a bidding fee auction, which is also known as a penny auction.

It is an even further object of the present invention to allow consumers to play all types of electronic games.

It is an even further object of the present invention to interface with Facebook.

It is an even further object of the present invention to provide a means for consumers to play games of chance.

It is an even further object of the present invention to use a laptop as a means to access the present invention.

It is an even further object of the present invention to interface with Living Social.

It is an even further object of the present invention to interface with Native American places of gaming.

It is an even further object of the present invention to provide a means for consumers to play On-line skill based games.

It is an even further object of the present invention to allow businesses and consumers to interchange all forms of cyber currency using printed and/or mobile barcodes.

It is an even further object of the present invention to allow businesses and consumers to interchange all forms of cyber currency using Radio Frequency Identification tags or cards, which is also known as RFID.

It is an even further object of the present invention to use location based services as an aid for the present invention to acquire basic demographic information about a consumer using their system.

It is an even further object of the present invention to provide a database operating on a set of remote servers in order to provide the necessary functionality for the system to operate.

It is an even further object of the present invention to use EPCGlobal RFID standards to provide functionality for the system.

It is an even further object of the present invention to provide an affinity card for consumers to use in conjunction with the present invention.

It is an even further object of the present invention to provide a means for a bidding fee auction for business and consumers.

No single embodiment need meet all of these objects. Different embodiments and different aspects of the invention may meet different objects. The present invention is not to be limited by the objects described herein.

### SUMMARY OF THE INVENTION

The present invention is an online backing system whereby one person can bet electronic currency on a game contestant for the chance to win additional virtual currency, if the contestant that is backed wins. In one example, the present invention can provide the conversion of real currency, at predetermined exchange rates, into online electronic currency or gaming “tokens” that can be used to back or bet on contestants participating in a specified game, tournament, contest, etc. The electronic currency or tokens can be accumulated, saved, and used to purchase ‘loot’, such as things of value, goods or services. This ‘loot’ would be provided from participating sponsors, via sponsor websites and real-world stores, that have agreed to participate in the system. This backing system has unlimited applications in any game or tournament of skill, whereby one contestant is pitted against another. Examples of games to which the systems and methods of the present invention described herein could be applied include, but are not limited to, poker and other games of skill, game shows, games of chance, and any digital game, for example World of Warcraft, whereby a competitive game can be played between two or more contestants, such as during online fantasy gaming tournaments.

In one implementation of the present invention, winnings are based on the total pot of “backs” for a particular game. For instance, if there were four contestants in a game and each contestant was backed by a different person, the person who picks the winning contestant wins the total pot of virtual currency or tokens bet. If multiple people choose the same contestant then the pot winnings would be split evenly between the backing parties. Once a person accumulates enough winnings, that person can purchase items from participating online/offline sponsors that have agreed to accept the electronic currency or tokens as payment.

According to one aspect of the present invention, a server provides a web interface that allows participants to access the system, the server is in communication with a participant database, a contestant database, and a sponsor database. The web interface allows a participant to use electronic currency to back a contestant in a competitive game of skill.

According to another aspect of the present invention a method includes via a web interface provided by a server, allowing a participant to place a bet using electronic currency on at least one contestant playing in a competitive game of skill. The method further includes distributing additional electronic currency to the participant if the contestant satisfies predetermined performance criteria. The method further includes storing a count of the participant's total amount of electronic currency in a participant database connected to the server.

According to another aspect of the present invention a method includes via a web interface provided by a server, allowing a participant to stake a contestant using electronic currency to allow the staked contestant to play in a competitive game of skill. If the backed contestant satisfied a predetermined performance criteria in the competitive game of skill sufficient to win electronic currency, the method provides for splitting the electronic currency winnings between the participant and the backed contestant. The method further includes storing a count of the participant's total amount of electronic currency in a participant database connected to the server.

### BRIEF DESCRIPTION OF THE DRAWINGS

FIG. 1 illustrates the online backing system described herein.

FIG. 2 illustrates a schematic layout of the server and databases for implementing the backing system.

FIG. 3 illustrates the transfer of contestant information for building contestant statistics.

FIG. 4 illustrates one method of backing in the form of placement of virtual bets.

FIGS. 5A and 5B illustrate an additional example of backing in the form of staking a contestant.

FIGS. 6A-6C illustrate examples of screen shots showing the use of advertising combined with gaming and backing of contestants.

FIG. 7 illustrates the exchange of electronic currency for ‘loot’.

### DETAILED DESCRIPTION OF THE PRESENT INVENTION

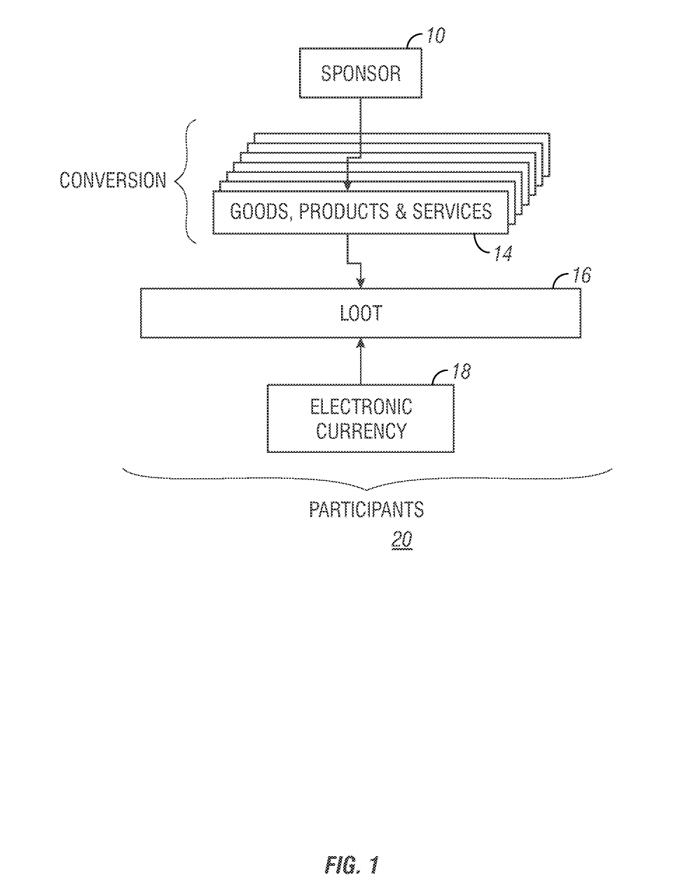

An online backing system is illustrated in FIG. 1. The system implements a computerized method in an online environment that in one implementation converts real currency into electronic currency that can be used to purchase ‘loot’. As used herein, electronic currency is any virtual form of currency, including online tokens, that has assigned value and that can be later exchanged within the described system for ‘loot’.

‘Loot’ is something of value, including but not limited to goods, services, electronic coupons or vouchers, discounts, etc. provided by sponsors that have agreed to participate in the system.

A sponsor is any entity that has agreed to participate in the backing system including, but not limited to, an advertiser that has paid a feed to advertise on the systems' website and/or that has provided ‘loot’, a fantasy gaming sponsor, a licensee, and ad-free gamers (i.e. gamers who have paid not to see ads during game play).

A participant is a person who backs a contestant in an effort to earn electronic currency.

A contestant is a person playing in a game that is backed by a participant.

In FIG. 1, sponsors 10 provide goods, products, services 14 that are pooled together in a ‘loot’ pool 16. Participants 20 in the system try to earn electronic currency 18 by backing a contestant in a game, which is used to purchase ‘loot’ that is selected by the participant based on how much electronic currency the participant has accumulated and how the selected items of ‘loot’ are valued.

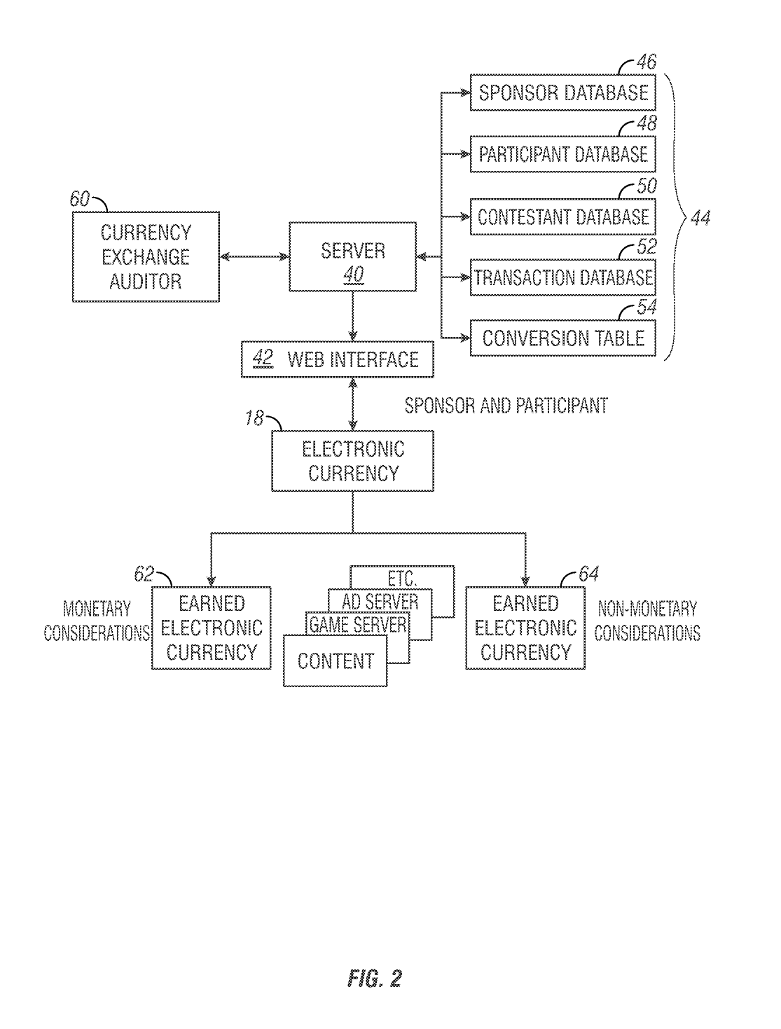

In FIG. 2, the present invention includes a server 40, a web interface 42 through which participants and sponsors can access the system, and a number of databases 44 accessed by the server 40, including a sponsor database 46 that can contain sponsor advertising, statistics on sponsor participation, and other sponsor related data; a participant database 48 that contains a list of participants and participant information, participant statistics, accumulated electronic currency for each participant, and other participant related information; a contestant database 50 that include a list of contestants, contestant information, contestant gaming statistics, contestant gaming results, and other contestant information; a transaction database 52 that tracks transactions such as the placement of bets or staking of contestants by participants, and the purchasing of ‘loot’ using electronic currency; and a conversion table 54 which determines the conversion rate of real currency into electronic currency if the system employs a real currency exchange option.

A currency exchange auditor 60, which can be a third party, can also access the server to audit the system to ensure integrity. FIG. 2 also shows options for obtaining electronic currency 18 as described in the present invention. The electronic currency 18 is obtained by participants primarily via a web interface. However, it is contemplated that electronic currency could be obtained by participants via sponsor websites, at sponsor stores or other ground locations. In one option, electronic currency can be purchased by exchanging real currency for some determined amount of electronic currency to provide purchased electronic currency 62. Electronic currency can also be earned via non-monetary considerations, for example by successfully backing a contestant to provide earned electronic currency 64. Electronic currency can also be earned by participants by agreeing to view advertisements, trailers, previews, digital content, etc., answering questionnaires, participating in surveys, referring users, gaming, loyalty, and for various other non-monetary considerations.

The communications between the various entities in the system of the present invention can be performed wirelessly, using a wired connection, or both. Sensitive communications, for example conversion of real currency in exchange for electronic currency, can be secure using encryption technology so the conversion cannot be compromised by malicious intent.

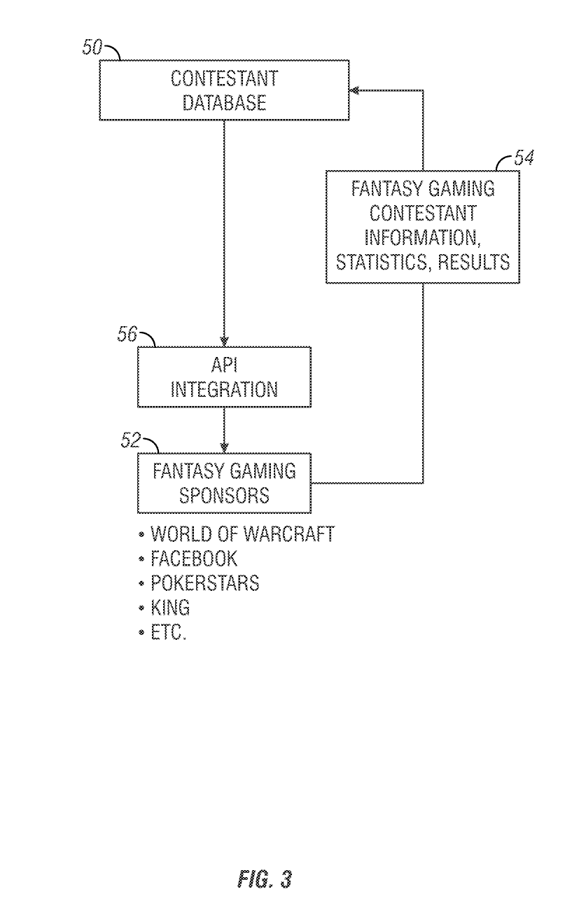

FIG. 3 shows the contestant database 50 and the transfer of contestant information for building contestant statistics. Fantasy gaming sponsors 52 sponsor fantasy games that are played by two or more contestants. The fantasy games can include any type of fantasy games such as World of Warcraft or King, fantasy poker, fantasy chess, and fantasy sports such as football, fantasy games on Facebook, and the like. Contestants can also play non-fantasy games such as game shows like Jeopardy. The gaming sponsors 52 track any number of performance variables and statistics of the contestants, and the contestant information, statistics and results 54 are uploaded into the contestant database 50 for use by participants in determining whether to back a contestant in a future game. Games are not limited to poker or games of chance, but also any digital game whereby a competitive game can be played between two or more players, such as online gaming tournaments. API Integration 56 may be used to facilitate communication between the sponsors 52 and the contestant database 50.

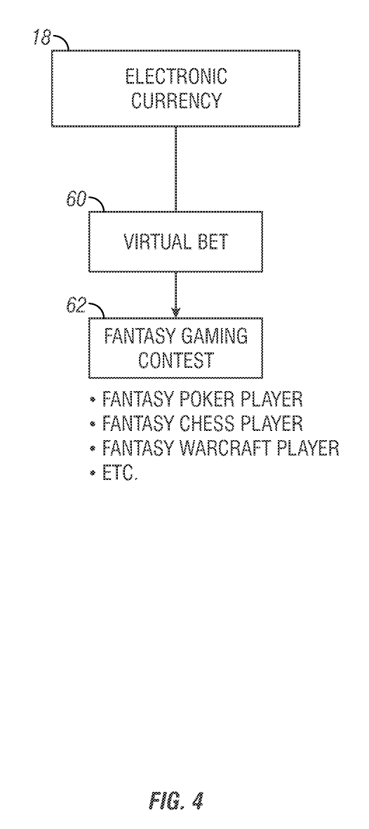

The term backing as used herein has a number of different meanings, all of which are intended to be encompassed herein. One example of backing is illustrated in FIG. 4. In FIG. 4 a participant places a virtual bet 60 using electronic currency 18 on one or more contestants that the participant wishes to back in a fantasy gaming contest 62. The bet can be that the backed contestant meets predetermined performance criteria during the game.

Any performance criteria can be used as the basis for the bet. The performance criteria can be based on quality of play, for example whether the contestant wins, finishes second or better, finishes third or better, etc., or based on quantity of play, for example how much the contestant plays or how long the contestant stays in the game.

Thus, in the example of FIG. 4, “backing” is the act of betting on one or more players to meet performance criteria. If the participant wins the bet, additional electronic currency can be won with an equal or lesser value.

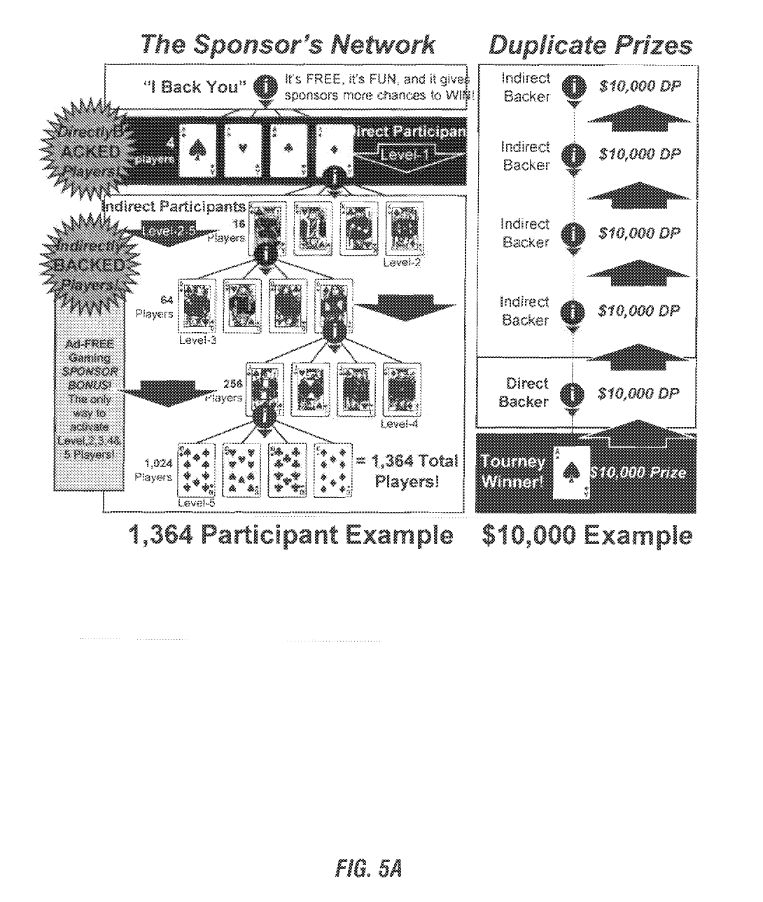

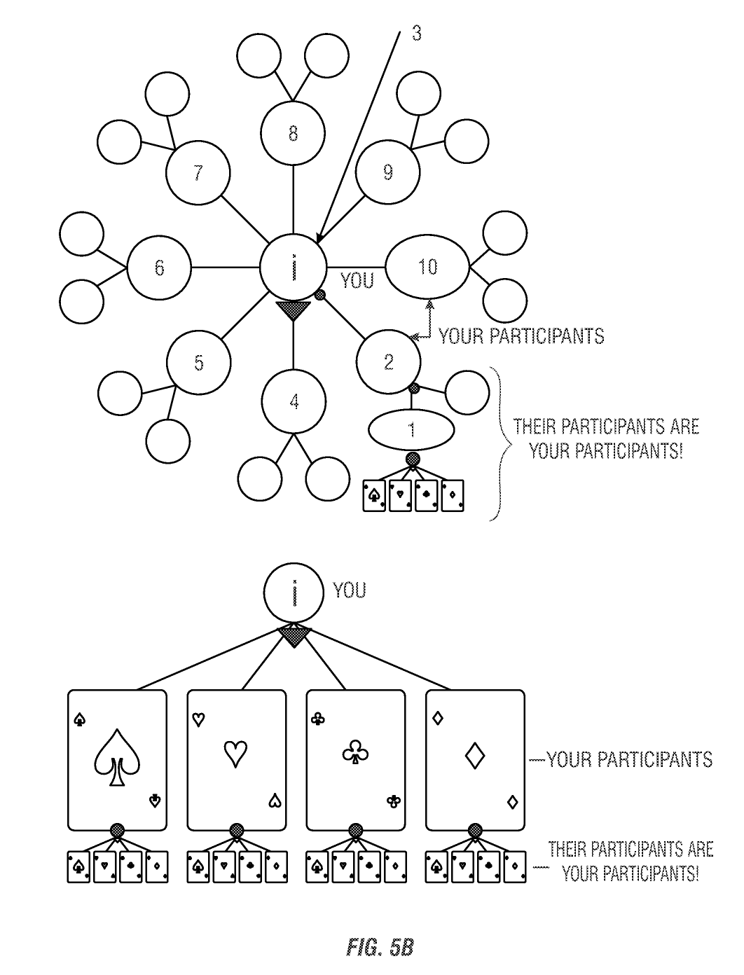

FIGS. 5A and 5B illustrate additional examples of backing. In FIGS. 5A and 5B, a fantasy gaming network is illustrated, whereby participants systematically increase their chance of winning by staking contestants to allow the contestant to play in the game. In the examples illustrated in FIGS. 5A and 5B, “backing” is the act of one person staking another to play in a game or tournament with the hope that the backed contestant wins. Any winnings are split between the backer and the contestant.

In FIG. 5A, multi-level backing is illustrated where a direct backer (i.e. a participant that directly backed a winning contestant) and indirect backers (i.e. backers that have referred the direct backer or indirect backers on lower levers to the system website), both win electronic currency if the backed contestant wins. In multi-level backing, backers build their networks by referring other participants to the fantasy gaming website. Multi-level backing systematically builds a network of participants that increases a backer's chances of winning. For every prize awarded to a winning contestant, an identical duplicate prize is awarded to the winning contestant's backers.

FIG. 5B illustrates another example of multi-level backing where the backed contestant 1, is backed by participant 2, who in turn was referred to the system by participant 3. If the backed contestant 1 wins, participants 2 and 3 also win electronic currency. Participant 3 can also refer participants 4-10 to the system, with participant 3 earning electronic currency if any contestants backed by participants 4-10 win.

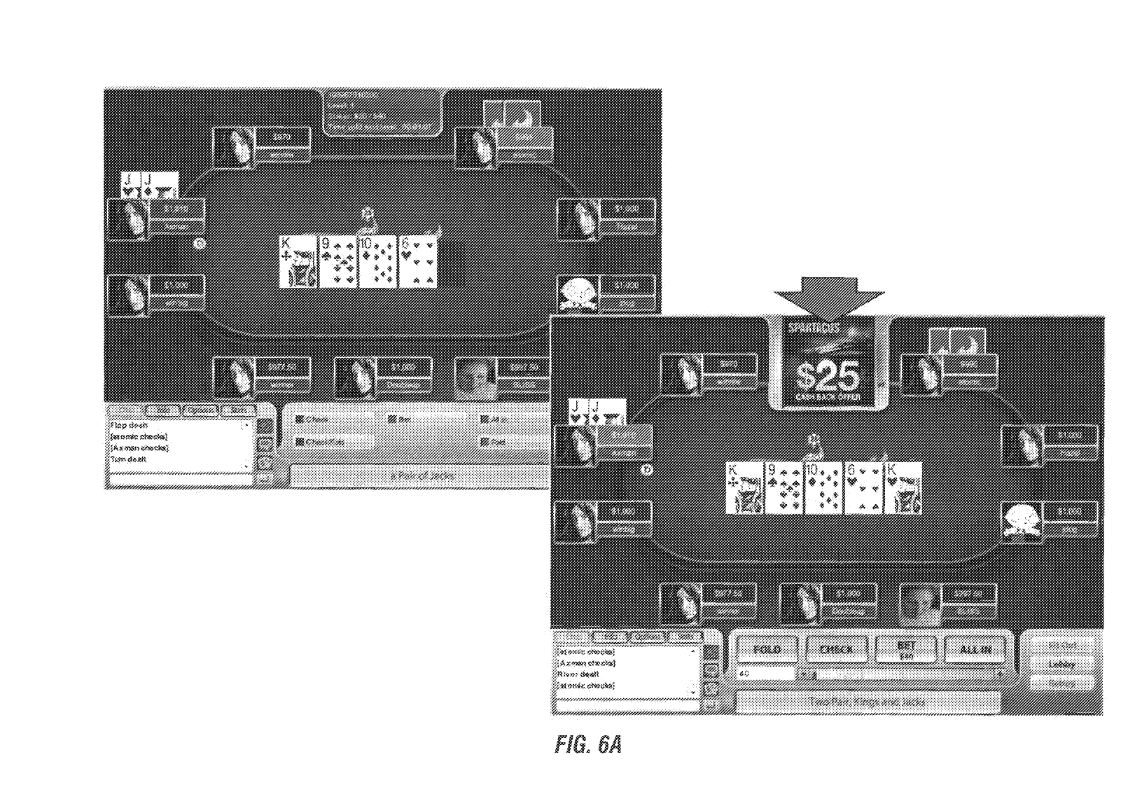

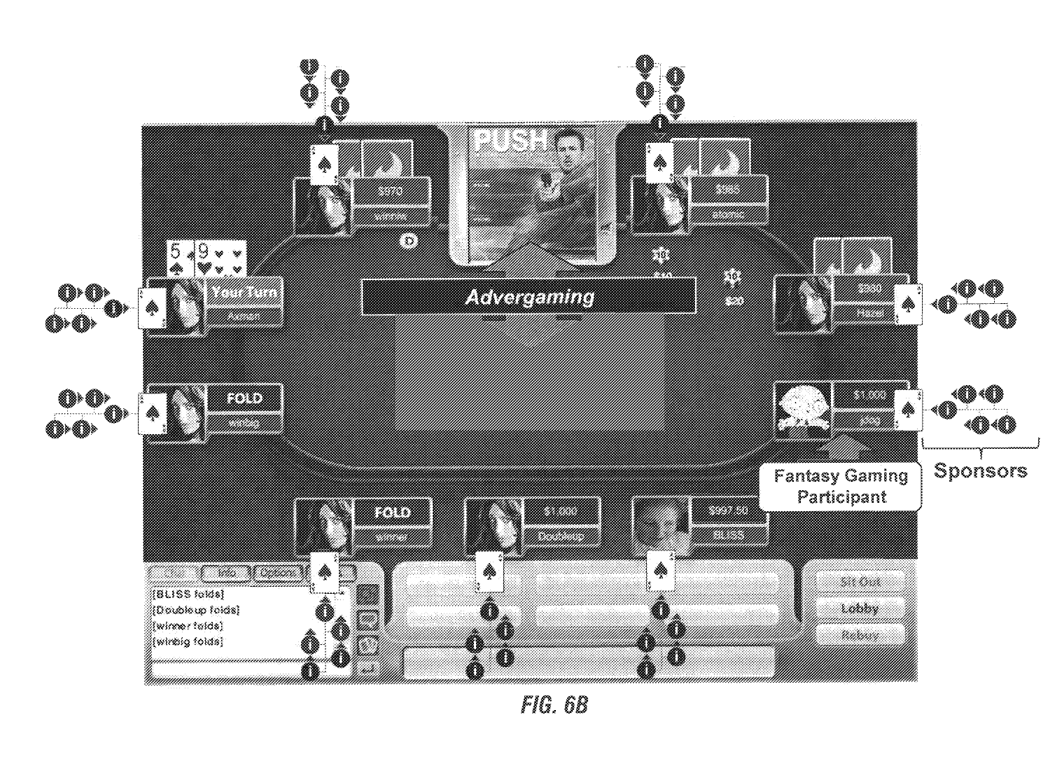

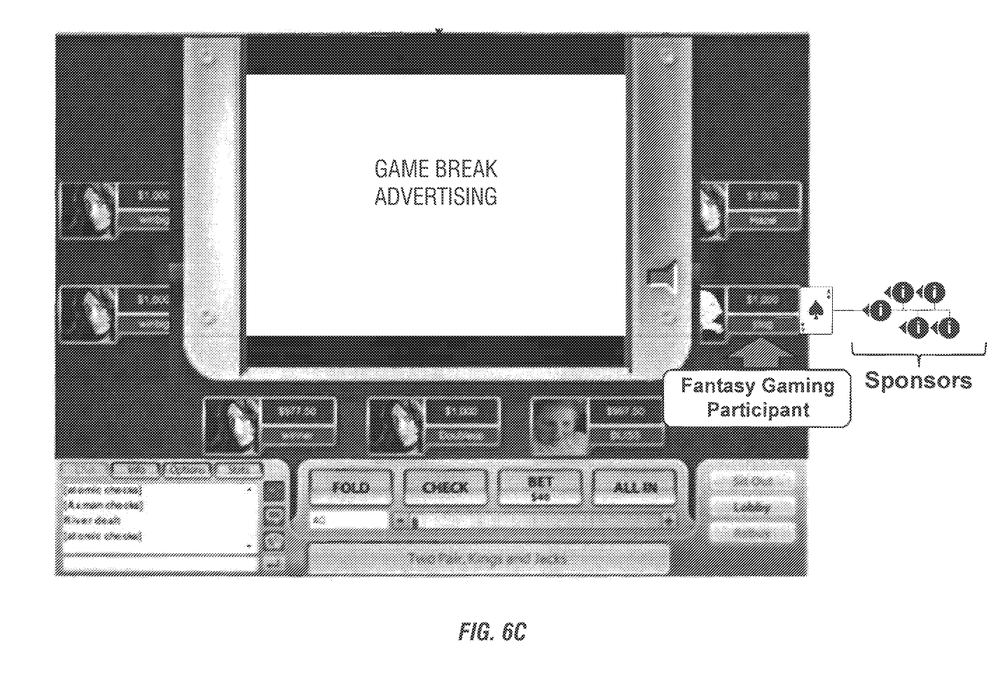

The system website can also include a portal that combines elements of Advergaming, Social Networking, TV, and Web technologies to enable free online and offline Fantasy Gaming competitions and tournaments for prizes. This is illustrated in FIGS. 6A-6C, which also shows backers backing certain contestants. Corporate sponsors can also exchange real world goods into prizes for online and offline brand and product exposure. Once a participant accumulates enough electronic currency, the participant can use the accumulated electronic currency to make purchases of real-world goods online and offline. The present invention can also include an in-game advertising engine whereby advertisers can advertise during gaming matches. The system can deliver targeted, rich media, online advertising in game, or through video commercials that run during tournaments breaks, half-times, or in-between various gaming segments.

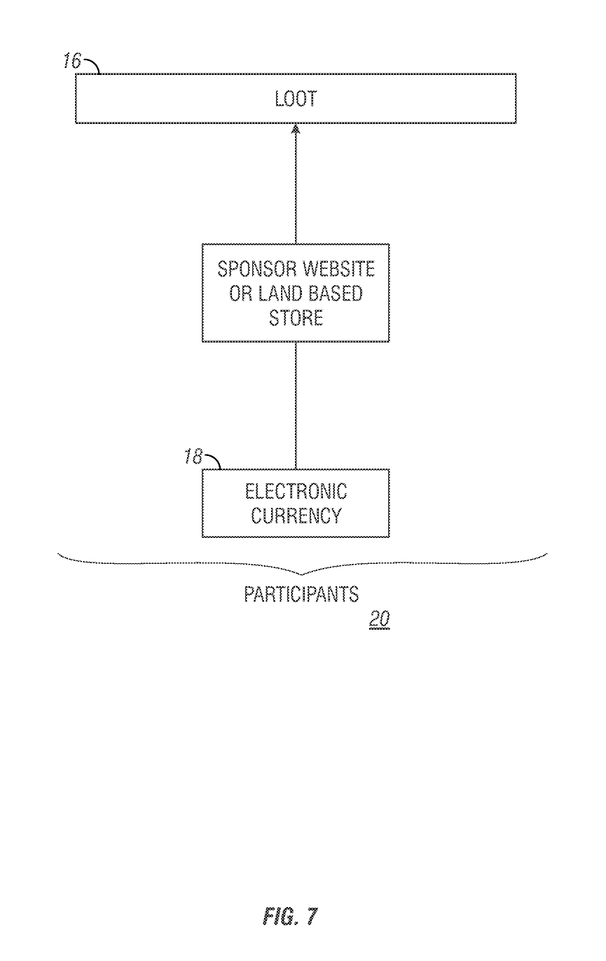

FIG. 7 illustrates the exchange of electronic currency for ‘loot’. A participant 20 with accumulated electronic currency 18 accesses the website to view available ‘loot’ 16, or accesses a sponsor's website, or goes to a sponsor's land based store, to exchange electronic currency for ‘loot’ 16.

The server of the present invention may include a computer readable storage medium or non-transitory machine readable medium for storing instructions for performing the functions performed by the server. The databases associated with the server store information on computer readable storage mediums or non-transitory machine readable storage mediums.

The present invention contemplates numerous options, alternatives and variations. For example, the present invention contemplates that businesses and consumers may interchange all forms of electronic currency using printed and/or mobile barcodes, or Radio Frequency Identification (RFID) tags or cards. Location based services may be used to acquire basic demographic information about a consumer using their system. Affinity cards may be provided to the users. A bidding fee auction may be used for businesses and customers.

The methods and systems described herein provides a virtual backing, banking, and betting solution for the gaming industry. However, the system, method, and apparatus described herein can be used for things to exchange wealth such as, but not limited to, stamps, coupons, money, stocks, bonds, credits, debits, bartering, chits, etc., and also collectible forms of wealth exchange, such as, but not limited to, stamps, coupons, money, stocks, bonds, credits, debits, bartering, chits, etc.

The invention may be embodied in other forms without departing form the spirit or novel characteristic thereof. The embodiments disclosed in this application are to be considered in all respects illustrative and not imitative. The scope of the invention is indicated by the appended claims rather than by the foregoing description; and all changes which come with the meaning and range of equivalency of the claims are intended to be embraced therein.

What is claimed is:

1. An on/offline gaming, contestant backing system, comprising:
a server providing a web interface that allows participants to access the system, the server being in communication with a participant database, a contestant database, and a sponsor database;
the web interface allowing a participant to use electronic currency to back a contestant in a competitive game of skill.

2. The system of claim 1 wherein the competitive game of skill is an online competitive game.

3. The system of claim 2 wherein the contestant is one of a plurality of contestants in the online competitive game and information of each of the plurality of contestants is stored in the contestant database.

4. The system of claim 1 wherein the electronic currency was purchased by or for the participant.

5. The system of claim 1 wherein the electronic currency was earned by the participant.

6. The system of claim 1 wherein the server provides for rewarding the participant if the contestant is successful in the competitive game.

7. The system of claim 6 wherein the reward is in the form of additional electronic currency.

8. The system of claim 7 wherein the electronic currency is redeemable for loot.

9. The system of claim 8 wherein the loot is provided by one or more sponsors and information associated with the one or more sponsors is stored in the sponsor database.

10. An on/offline gaming, player backing method, comprising:
via a web interface provided by a server, allowing a participant to place a bet using electronic currency on at least one contestant playing in a competitive game of skill;
distributing additional electronic currency to the participant if the contestant satisfies predetermined performance criteria; and
storing a count of the participant's total amount of electronic currency in a participant database connected to the server.

11. The method of claim 10 further comprising redeeming at least a portion of the total amount of electronic currency for loot.

12. The method of claim 11 wherein the loot is physical loot.

13. The method of claim 10 further comprising converting at least a portion of the total amount of electronic currency for currency.

14. The method of claim 10 wherein the server is connected to a sponsor database comprising sponsor data for at least one sponsor who provides at least a portion of the additional electronic currency.

15. The method of claim 10 wherein the server is connected to a sponsor database comprising sponsor data for at least one sponsor who provides loot and wherein the method further comprises redeeming at least a portion of the total amount of electronic currency for the loot.

16. The method of claim 10 wherein the server is connected to a contestant database comprising contestant data for a plurality of contestants competing in the competitive game of skill and the method further comprising distributing additional electronic currency to the contestant if the contestant satisfies the predetermined performance criteria.

17. An on/offline gaming, player backing method, comprising:
via a web interface provided by a server, allowing a participant to stake a contestant using electronic currency to allow the staked contestant to play in a competitive game of skill;
if the backed contestant satisfied a predetermined performance criteria in the competitive game of skill sufficient to win electronic currency, splitting the electronic currency winnings between the participant and the backed contestant; and
storing a count of the participant's total amount of electronic currency in a participant database connected to the server.

18. The method of claim 17 further comprising if the backed contestant satisfied the predetermined performance criteria in the competitive game of skill, storing a count of the backed contestant's total amount of electronic currency in a contestant database connected to the server.

19. The method of claim 17 further comprising redeeming at least a portion of the total amount of electronic currency for loot.

20. The method of claim 19 wherein the server is connected to a sponsor database containing information identifying amount of loot provided by one or more sponsors of the competitive game.
